(19) United States
(12) Patent Application Publication
(10) Pub. No.: US 2023/0086842 A1
(43) Pub. Date: Mar. 23, 2023

(54) SENSOR SYSTEM AND METHOD FOR IDENTIFYING A STATE OF AT LEAST ONE MACHINE

(71) Applicant: Rolls-Royce Deutschland Ltd & Co KG, Blankenfelde-Mahlow (DE)

(72) Inventor: Shankar Deepak SRINIVASAN, Berlin (DE)

(21) Appl. No.: 17/795,992

(22) PCT Filed: Jan. 18, 2021
(86) PCT No.: PCT/EP2021/050910

§ 371 Date: Jul. 28, 2022

(30) Foreign Application Priority Data
Jan. 31, 2020 (DE) 10 2020 201 239.3

(51) Int. Cl. G01M 15/14; F02C 7/00

(52) U.S. Cl. CPC G01M 15/14; F02C 7/00

(57) ABSTRACT

A sensor system for identifying a state of at least one machine includes one or more sensors for acquiring measured values of the at least one machine, at least one communication interface, and an evaluation unit configured to acquire a plurality of data sets containing measured values of the one or more sensors, select a portion of the data sets by active learning, and provide the selected portion of the data sets to the at least one communication interface for the purpose of identifying the state of the at least one machine.

The present patent document is a § 371 nationalization of PCT Application Serial No. PCT/EP2021/050910, filed Jan. 18, 2021, designating the United States, which is hereby incorporated by reference, and this patent document also claims the benefit of German Patent Application No. 10 2020 201 239.3, filed Jan. 31, 2020, which is also hereby incorporated by reference.

### TECHNICAL FIELD

The present disclosure relates to a sensor system and a method for identifying a state of at least one machine, and to a computer program product.

### BACKGROUND

At present, people regularly select certain data, for example, to identify faulty sensors or other components of machines. However, ever-increasing amounts of data for identifying the state of machines may far exceed the available working time. Alternatively, it is possible to provide analysis tools which allow automatic state identification for large amounts of data. However, such analysis tools may have to be configured to a specific intended purpose, which in many cases is too time-consuming.

It is also known practice to train artificial intelligence, AI, with data and a classification of the data, for example, by providing a photo of a bicycle and stating “bicycle”.

One difficulty, however, lies in the large amount of training data that makes it difficult to train the AI as well as possible.

### SUMMARY

The object of the present disclosure is to enable improved detection of the state of machines.

One aspect provides a sensor system for identifying a state of at least one machine. The sensor system includes one or more sensors for acquiring measured values of at least one machine, at least one communication interface, and an evaluation unit. The evaluation unit is configured to acquire a plurality of data sets, each data set including measured values of the one or more sensors. Furthermore, the evaluation unit is configured to select a portion of the data sets by active learning and provide the selected portion of the data sets to the at least one communication interface.

Active learning is a special case of machine learning in which a (learning) algorithm is designed to (interactively) query a user (or another information source) to obtain desired results at new data points. In this case, particularly relevant and/or decision-critical data sets may thus be used specifically to identify the state of the at least one machine, which enables improved detection of the state of machines. For this purpose, for example, a measure of the relevance of one or more data sets to the decision is determined. This enables, for example, an optimized selection of training data sets for a machine learning model which may then automatically and precisely monitor the state of the at least one machine after a particularly short training period.

The sensors are each configured to measure a physical variable, (e.g., a temperature, a speed, a rotational speed, or a pressure). The measured values may be acquired in the form of time series data. For example, the evaluation unit receives a plurality of temporally successive measured values from one or more sensors.

The evaluation unit includes, for example, one or more computers. The at least one communication interface may include a software interface and/or a hardware interface. The data sets that are provided at the at least one communication interface and are selected by active learning allow the state of the at least one machine to be identified, for example, by a user.

The evaluation unit may be configured to specify an order for the selected data sets by active learning. In this way, the most relevant data sets may be processed first, so that the identification of the state may be improved particularly quickly.

The evaluation unit may also be configured to divide the plurality of data sets into at least two groups with regard to the at least one parameter of the data sets by a separation line and to select the portion of the data sets based on the distance between the parameters of the respective data sets and the separation line. This makes it possible to request a classification of precisely those data sets with which a machine learning model has or would have the greatest difficulties. If the machine learning model is trained precisely with these data sets, it may distinguish between the different classifications with particular precision.

The evaluation unit is optionally configured to receive a classification of the data sets provided at the at least one communication interface with regard to the state of the at least one machine. For example, the classification includes two or three decision options. For example, a selection is made from two answers (e.g., A or B) or from three answers (e.g., A, B, or C) for the classification. The classification corresponds, for example, to the result of a yes/no decision or a decision between the options A (e.g., yes), B (e.g., no) and C (e.g., “unknown” or “undefined”). For example, the evaluation unit receives the classification in the form of classification data units in each case. The classification data units each include, by way of example, the statement “yes” or “no” or another indication of positive or negative, e.g., 1 or 0.

Furthermore, the evaluation unit may be configured to analyze the classified data sets, (e.g., by machine learning), in order to acquire at least one parameter of the respective data set (e.g., a minimum and/or a maximum and/or a standard deviation).

According to one development, the evaluation unit is configured to use the acquired at least one parameter of the classified data sets to train a machine learning model. Because the machine learning model is trained on the basis of the selection of the portion of the data sets made by active learning, a significantly improved quality of the training, and consequently of the decision-making using the machine learning model trained in this way is possible. Such training also allows extensive automation. Furthermore, the amount of data needed to train the machine learning models may be reduced because optimal training data sets may be selected. Furthermore, a simple adaptation to a variety of different applications is possible. An adaptation of the machine learning model to different applications beyond training is not necessary for many applications. To train the machine learning model, for example, properties of the respective selected portion of the data are extracted in the form of the at least one parameter (e.g., a maximum value, a minimum value, a median, a mean average, a variance or the like), the training being carried out based on these parameters. At least one of the parameters may be a statistical parameter. The machine learning model may be or include a classification model. In particular, the machine learning model may be or include an artificial neural network.

The evaluation unit is optionally configured to use the trained machine learning model to classify further data sets containing measured values, in particular in order to identify the state of at least one machine. This makes it possible to identify the state of a machine automatically in a particularly reliable manner using a machine learning model that has been trained in an optimized manner. In particular, it is possible in this way to classify a particularly large number of data sets with a high degree of precision.

The at least one machine may be a gas turbine engine or a multiplicity of gas turbine engines. Particularly in the case of gas turbine engines, it may be desirable to identify a deteriorating state of a sensor or of a component monitored by a sensor as early as possible, which is made possible by the machine learning models trained as described above.

One aspect provides a method for identifying a state of at least one machine. The method includes: generating measured values of the at least one machine by one or more sensors; acquiring, with an evaluation unit, a plurality of data sets containing measured values of the one or more sensors; selecting, with the evaluation unit and by active learning, a portion of the data sets; and providing the selected portion of the data sets to at least one communication interface for the purpose of identifying the state of the at least one machine.

The sensor system according to any configuration described herein may be used in the method.

Provision is optionally made for the evaluation unit to receive a classification of the data sets provided at the at least one communication interface with regard to the state of the at least one machine and, optionally, to train a machine learning model on the basis thereof. The trained machine learning model may be used to classify further (in particular not yet classified) data sets containing measured values. The corresponding machine may be serviced in this case depending on the classification of the further data sets. For this purpose, the evaluation unit may generate a corresponding command. Alternatively, or additionally, a message is sent.

One aspect provides a computer program product including instructions which, when executed by one or more processors, cause the one or more processors to perform the acts of the method according to any configuration described herein.

### BRIEF DESCRIPTION OF THE DRAWINGS

Embodiments will now be described by way of example with reference to the figures, in which:

FIG. 1 depicts an example of an aircraft in the form of an airplane having a plurality of gas turbine engines.

FIG. 2 depicts a sectional side view of an example of a gas turbine engine.

FIG. 3 depicts an example of a sensor system for identifying a state of at least one machine.

FIG. 4 depicts details of the system according to FIG. 3.

FIGS. 5 to 8 depict different examples of measured values.

FIG. 9 depicts an example of a method for training a machine learning model.

FIG. 10 depicts an example of a configuration of an evaluation unit of the system according to FIG. 3.

FIGS. 11A-11C depict examples of details of active learning.

### DETAILED DESCRIPTION

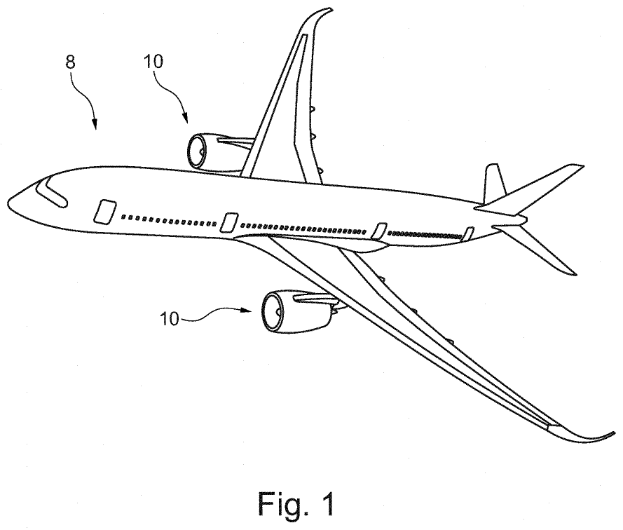

FIG. 1 shows an aircraft 8 in the form of an airplane. The aircraft 8 includes a plurality of gas turbine engines 10.

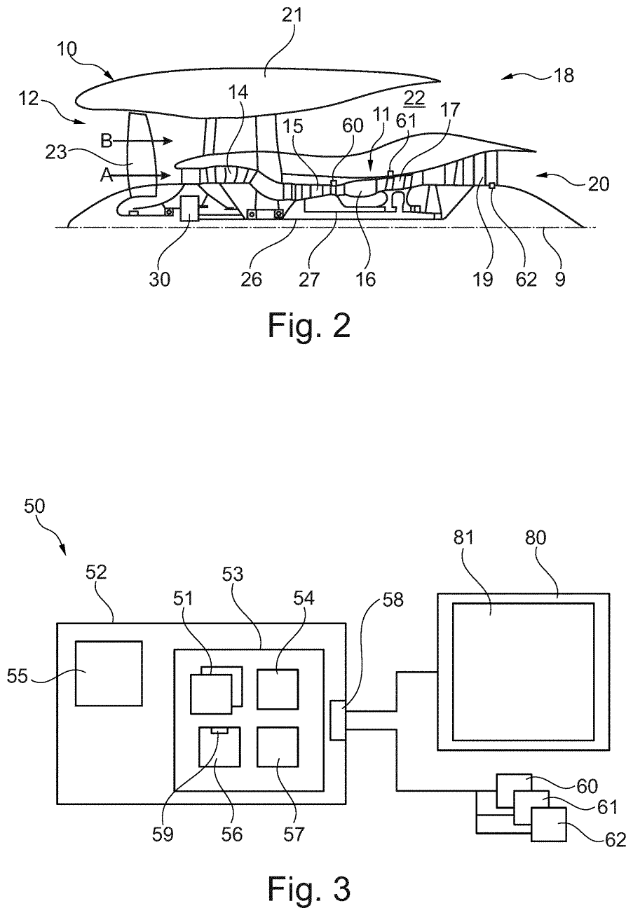

FIG. 2 illustrates one of the gas turbine engines 10 of the aircraft 8 with a main axis of rotation 9. The gas turbine engine 10 includes an air inlet 12 and a fan 23 that produces two air flows: a core air flow A and a bypass air flow B. The gas turbine engine 10 includes a core 11 that receives the core air flow A. When viewed in the order corresponding to the axial direction of flow, the core engine 11 includes a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive the turbines, before being expelled through the nozzle 20 to provide a certain propulsive thrust. The high-pressure turbine 17 drives the high-pressure compressor 15 by a suitable connecting shaft 27. The fan 23 may provide the bulk of the propulsive thrust. The epicyclic planetary gear box 30 is a reduction gear box.

It is noted that the terms “low-pressure turbine” and “low-pressure compressor” as used herein may be taken to mean the lowest-pressure turbine stage and lowest-pressure compressor stage (e.g., not including the fan 23) respectively, and/or the turbine and compressor stages that are connected together by the connecting shaft 26 with the lowest rotational speed in the engine (e.g., not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 may be referred to as a first, or lowest-pressure, compression stage.

Other gas turbine engines in which the present disclosure may be used may have alternative configurations. For example, such engines may have an alternative number of compressors and/or turbines and/or an alternative number of connecting shafts. As a further example, the gas turbine engine shown in FIG. 2 has a split flow nozzle 20, 22, meaning that the flow through the bypass duct 22 has its own nozzle, which is separate from and radially outside the engine core nozzle 20. However, this is not restrictive, and any aspect of the present disclosure may also apply to engines in which the flow through the bypass duct 22 and the flow through the core 11 are mixed or combined before (or upstream of) a single nozzle, which may be referred to as a mixed flow nozzle. One or both nozzles (whether mixed or split flow) may have a fixed or variable region. Although the example described relates to a turbofan engine, the disclosure may be applied for example to any type of gas turbine engine, for example an open-rotor engine (in which the fan stage is not surrounded by an engine nacelle) or a turboprop engine.

The geometry of the gas turbine engine 10, and components thereof, is/are defined by a conventional axis system, which includes an axial direction (which is aligned with the axis of rotation 9), a radial direction (in the direction from bottom to top in FIG. 2), and a circumferential direction (perpendicular to the view in FIG. 2). The axial, radial and circumferential directions are perpendicular to one another.

A plurality of sensors is arranged on the gas turbine engine 10, of which a plurality of sensors 60-62 arranged at different points on the gas turbine engine 10, specifically temperature sensors for measuring temperatures, are illustrated here by way of example.

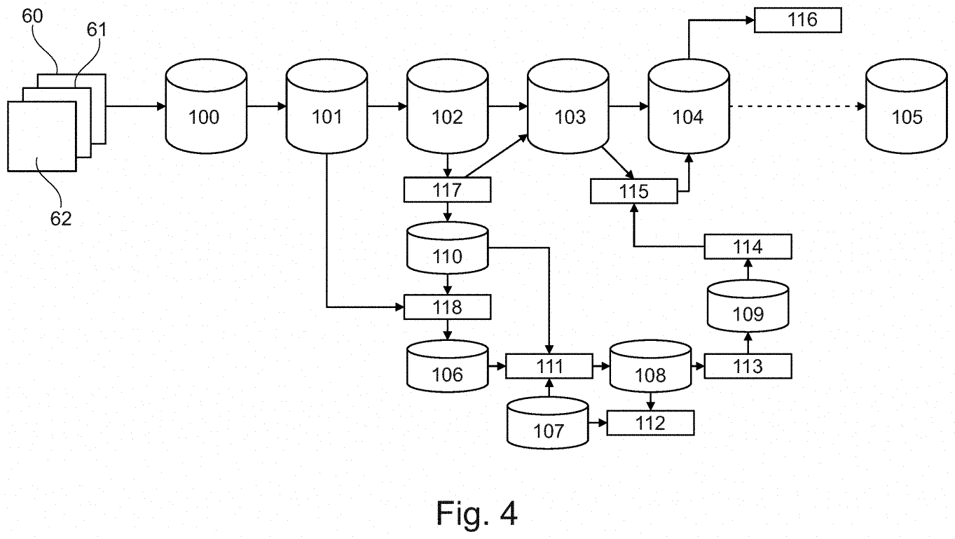

FIG. 3 shows a sensor system 50. The sensor system 50 includes the sensors 60-62 arranged in the present case on the gas turbine engine 10, an evaluation unit 52, and at least one communication interface 58, 59, (in the depicted example, two communication interfaces 58, 59). The evaluation unit 52 includes, for example, one or more computers (e.g., arranged next to one another or at a distance from one another).

The evaluation unit 52 is configured to receive a plurality of data sets, each data set containing measured values of the sensors 60-62. The evaluation unit 52 is further configured to select a portion of the data sets by active learning. Furthermore, the evaluation unit 52 is configured to provide the selected portion of the data sets to the communication interface 58 for the purpose of identifying the state of at least one machine, in this case the gas turbine engine 10.

At least one machine learning model 51 is stored in a memory 53 of the evaluation unit 52, in particular a plurality of machine learning models 51 are stored or may be stored. The plurality of machine learning models 51 may represent a plurality of instances of the same machine learning model. The evaluation unit 52 is communicatively coupled to the sensors 60-62 via a communication interface 58 in order to acquire data, specifically measured values, from them. Furthermore, the evaluation unit 52 is communicatively coupled to at least one interface 81 (via the communication interface 58 or a further communication interface). In the present example, the interface 81 is in the form of a graphical user interface (GUI) and may be displayed on a display 80.

Via the interface 81, a user may classify one or more data sets selected by the active learning. In this example, the user may also select that portion of the measured values in the respective data set which is the reason for the selected classification. For example, the user may decide whether a respective data set includes measured values indicative of a particular state of the gas turbine engine 10, such as the wear or defect of a component. The sensor system 50 may receive this classification (and optionally the selected portion of the measured values) of the respective data set via the communication interface 58 and may thus train the machine learning model 51.

The machine learning models 51 are designed for machine learning and in the present example include a random forest and/or an artificial neural network. The sensor system 50 also includes a further machine learning model 57 which will be explained in yet more detail below. Based on the trained machine learning models 51, 57, data sets containing measured values may be classified in order to automatically make data-driven decisions, for example, to trigger maintenance work.

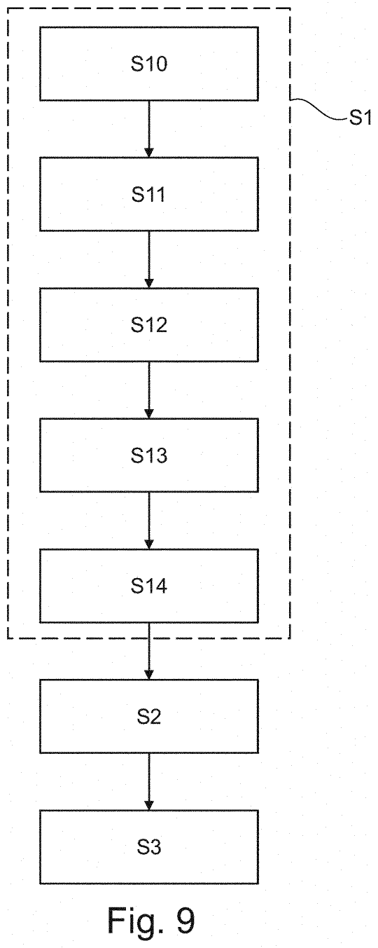

The memory 53 also stores instructions 54 which are part of a computer program product which causes a processor 55 of the evaluation unit 52 to carry out the method shown in FIG. 9 (or at least part of it, in particular at least acts S11 to S13). The memory 53 may be a non-volatile memory. The processor 55 may include a CPU, a GPU, and/or a tensor processor.

The evaluation unit 52 also includes a selector 56 (stored, for example, in the memory 53). The selector 56 is configured for active learning. For this purpose, the selector 56 is configured, for example, to select one or more data sets (as a subset) from a multiplicity of data sets based on a specified rule, for example, to select in each case that data set which is to be used for the next classification, for example, for which the selector 56 determines the greatest probability of this data set having the strongest training effect for the machine learning model 51. The selector 56 makes this data set available to the interface 81 via the communication interface 58 in each case. Furthermore, the selector 56 may provide selected data sets via a software-based communication interface 59, e.g., to one or more machine learning models 51, 57. The selector 56 determines, for example, an order for the selected data sets.

The evaluation unit 52 is optionally stationed on the ground and the gas turbine engine 10 may be moved relative thereto.

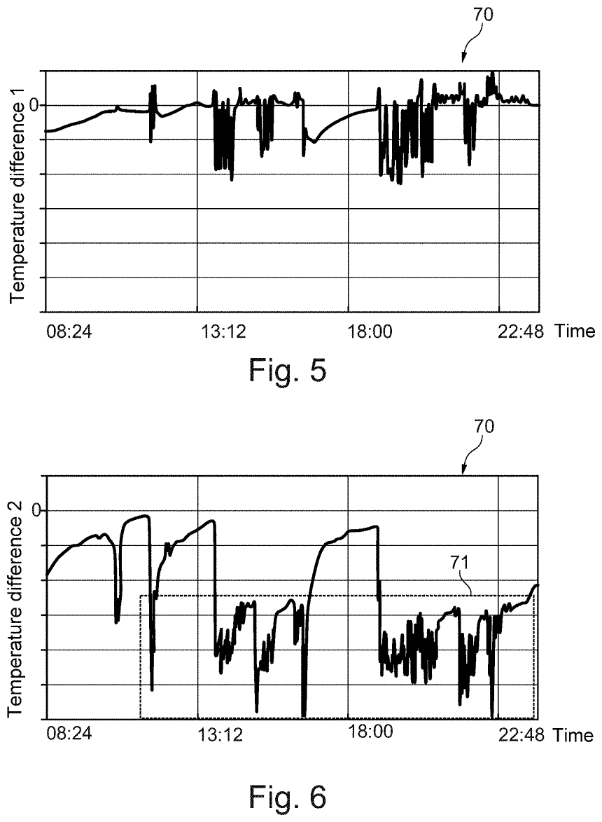

FIG. 4 shows further details of the sensor system 50.

A database 100 stores measured values from the sensors 60-62 in the form of a multiplicity of time series and as raw data. The time series originate, for example, from a plurality of flights of the gas turbine engine 10, from the plurality of gas turbine engines 10 of the aircraft 8, and/or from gas turbine engines 10 of a plurality of aircraft 8 (or, e.g., from a plurality of machines). The transmission from the sensors 60-62 to the database 100 takes place, for example, via a data cable or wirelessly, (such as via GSM or another mobile communication standard), in particular via the communication interface 58. The database 100 is stored in the memory 53, for example.

Optionally, the data stored in the database 100 are preprocessed and stored in a further database 101, which may also involve a transient flow of data. For example, data that are not of interest cannot be transferred in order to simplify further processing.

Optionally, the measured values are preprocessed further and stored in a further database 102 in order analyze the measured values with regard to suitable time series. This analysis takes place in block 117. In this case, data sets containing measured values are selected from a larger number of data sets.

In block 117, suitable candidates are selected from data sets, in particular each with a time series from a sensor 60-62 or each with a plurality of time series (in particular spanning the same time period) from a plurality of the sensors 60-62. The portion of the data sets is selected in this case by active learning. The selected portion of the data sets is provided to the communication interface 58 for the purpose of identifying the state of the at least one machine 10.

In the case of data that form the basis of a decision-making process, measured values in specific time intervals may allow particularly precise conclusions to be drawn about the state of the sensor or a machine monitored by the sensor. In particular, if a gas turbine engine sensor is involved, for example, certain signatures in the data may be an indication of a deteriorating state of the sensor or of a component that is monitored or may be monitored thereby.

The selected candidates or pointers to them are optionally stored in a database 110.

For example, an import script retrieves these candidates from the database 102 (or the database 101) in block 118 and provides them to a block 111 (optionally via a further database 106).

In block 111, a classification data unit and a selected portion of the measured values of the respective candidate are respectively acquired for all or for some of the candidates. The classification data units indicate a classification of the candidate into one of a plurality of predefined classes. The classification data units and/or the selected portions of the measured values are provided by one or more users in this case. This takes place, for example, via the interface 81 and/or the communication interface 58.

The classification data units and selected portions of the candidates are stored in a database 108 and provided to a block 112. In block 112, one instance of the machine learning model 51 is trained (e.g., per user) on the basis of the classification data units and selected portions of the candidates that were provided by the user. For this purpose, properties of the selected portion of the measured values are extracted in each case in the form of parameters. Optionally, the extracted parameters and/or values calculated therefrom, e.g., ratios of two parameters, are then the input parameters for the training. Examples of such parameters will be explained further below in connection with FIG. 7.

The data stored in the database 108 are provided to a block 113 which may also access the database 107. In block 113, the (optional) higher-level machine learning model 57 is generated. The higher-level machine learning model 57 optionally corresponds to the machine learning model 51, but is trained, for example, with the (optionally weighted and/or selected) input parameters from a plurality of instances of the machine learning model 51.

The higher-level machine learning model 57 and/or the input parameters thereof is/are stored in a database 109 (which is stored, for example, in the memory 53).

In optional block 114, the generation of the higher-level machine learning model 57 is displayed on a user interface.

The database 103 includes the data from the database 102 to which optional selection or correction scripts have been applied. Alternatively, instead of the databases 102 and 103, only the database 102 is provided.

In block 115, the higher-level machine learning model 57 is applied to the measured values in the database 103 (or 102) in order to classify the measured values. The results of the classification from block 115 are stored in a database 104, optionally also data from the database 103 (or 102).

In block 116, data-driven decisions are made, for example, the execution of maintenance work is triggered. For example, it was recognized from the classification that one of the sensors 60-62 or a component of the gas turbine engine 10 (or, e.g., a machine monitored by the sensor system 50) that is monitored by the sensors 60-62 is defective and needs to be replaced. Optionally, a message indicating a decision is generated and transmitted, e.g., by e-mail.

The data on which the decisions are based are optionally stored in a database 105. The databases 100 to 104 (which may also be logical steps through a flow of data) are optionally part of an engine equipment health management, EHM, of the gas turbine engine 10 and/or are stored in the memory 53. In particular, the database 105 may be stationed on the ground, for example. Furthermore, it should be noted that the databases 100, 101, 102, 103, 104, and/or 105 (optionally all databases) may have separate physical memories or alternatively may be databases of a logical architecture, wherein e.g., a plurality or all of the databases have the same physical memory.

One or more of the blocks 111 to 118, in particular all of the blocks 111 to 118, may be stored in the memory 53 in the form of instructions 54 and may be executed by the processor 55.

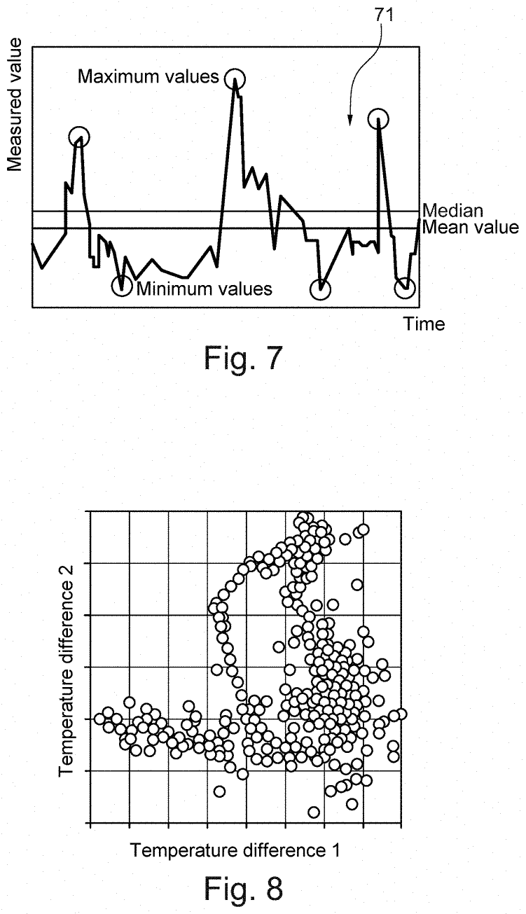

FIG. 5 shows exemplary measured values 70 in the form of time series data. A multiplicity of measured values is plotted against time here. Specifically, the measured values indicate a (first) temperature difference that may be determined, and has been determined here, using two sensors, which are arranged at a distance from one another, of a machine, in the present case a diesel engine, (alternatively, for example, analogously one or two of the sensors 60-62) in the form of temperature sensors.

FIG. 6 shows, by way of example, further measured values 70 in the form of time series data. Here too, a multiplicity of measured values is plotted against time, specifically over the same time period as the measured values in FIG. 5. Specifically, the measured values in FIG. 6 indicate a (second) temperature difference that may be determined, and has been determined here, using two sensors, which are arranged at a distance from one another, of the machine, in the present case the diesel engine, (alternatively, for example, analogously one or two of the sensors 60-62) in the form of temperature sensors, specifically a different pair of sensors 60-62 than in FIG. 5.

Furthermore, a selected portion 71 of the measured values 70 is illustrated in FIG. 6. The selected portion 71 includes conspicuous ranges of the measured values. When measured values are conspicuous depends on the respective application. In the present example, values of the temperature difference below a certain limit and strong fluctuations in the values are conspicuous. The selected portion 71 may include one or more subperiods of time of the measured values 70 (along the X axis). Optionally, the selected portion 71 also includes a limitation along the Y axis.

FIG. 7 illustrates exemplary parameters that may be calculated from an exemplary selected portion 71 of measured values 70.

The parameters may be a maximum value, a minimum value, a median, a mean average, a variance, the sum of the squared individual values, the length of the selected portion in the time direction, an autocorrelation or a parameter derived therefrom, the number of values above or below the mean average, the longest time interval above or below the mean average, the sum of the gradient sign changes, a gradient, a standard deviation, and/or a number of peaks. Some of these parameters are graphically highlighted in FIG. 7. One or more of the parameters, (e.g., all of the parameters), may be used as input parameters for training the corresponding machine learning model 51. Furthermore, ratios of the parameters mentioned may be formed and used as input parameters for the training, (e.g., mean average/variance, length/sum of the squared individual values, or other ratios).

FIG. 8 illustrates that time series data from a plurality of sensors may optionally be plotted multidimensionally (here two-dimensionally), with the result that the selected portion 71 of the measured values 70 may be selected multidimensionally. In this case, for example, a plurality of measured values that are correlated with one another may show particularly clear conspicuous features which may then be selected particularly easily and precisely. For example, a point in the multidimensional representation corresponds to a plurality of different measured values at the same point in time.

Optionally, clusters of data points (in particular in the selected portion) are determined in the multidimensional representation and e.g., the distances of the clusters from one another and/or the sizes, e.g., radii, of the clusters and/or the number of data points they contain are determined.

FIG. 9 shows a method for classifying measured values, including the following acts.

Act 51 includes providing a trained machine learning model, in particular a trained higher-level machine learning model 57.

For this purpose, for example, a method for training the machine learning models 51 is carried out, including acts S10 to S14.

Act S10 includes generating measured values of at least one machine, in particular at least one gas turbine engine, using the one or more sensors 60-62, the measured values 70 being acquired in particular in the form of time series data and in particular indicating measured values of one or more gas turbines 10.

Act S11 includes acquiring, by the evaluation unit 52, data sets containing measured values 70 obtained by the one or more sensors 60-62.

Act S12 includes selecting, with the evaluation unit 52 and by active learning, a portion of the data sets.

Act S13 includes providing, in particular by the evaluation unit 52, the selected portion of the data sets at the communication interface 58 (in particular for display at the interface 81) for the purpose of identifying the state of the at least one machine.

Act S13 may also include receiving, by the evaluation unit 52, classification data units relating to the measured values 70, the classification data units received by the evaluation unit 52 relating to the data sets provided at the communication interface 58. Act S13 also includes receiving, by the evaluation unit 52 and for each of the classification data units, a selected portion 71 of the measured values 70.

Act S14 includes training, by the evaluation unit 52, one or more machine learning models 51 on the basis of the classification data units and the selected portions 71 of the measured values 70, the machine learning models 51 may include an artificial neural network.

Optionally, a plurality of machine learning models 51, e.g., a plurality of instances of the same type of machine learning model 51, are trained (e.g., by each of the above acts being carried out by a plurality of users) and a higher-level machine learning model 57 is calculated from the plurality of machine learning models 51 (instances).

Act S2 includes classifying, by the evaluation unit 52, data sets containing measured values 70 acquired by one or more sensors 60-62, using the at least one machine learning model 51 and/or the higher-level machine learning model 57.

The optional act S3 includes generating, by the evaluation unit 52 and on the basis of the classification of the data sets of the measured values 70, a command which indicates performance of maintenance work.

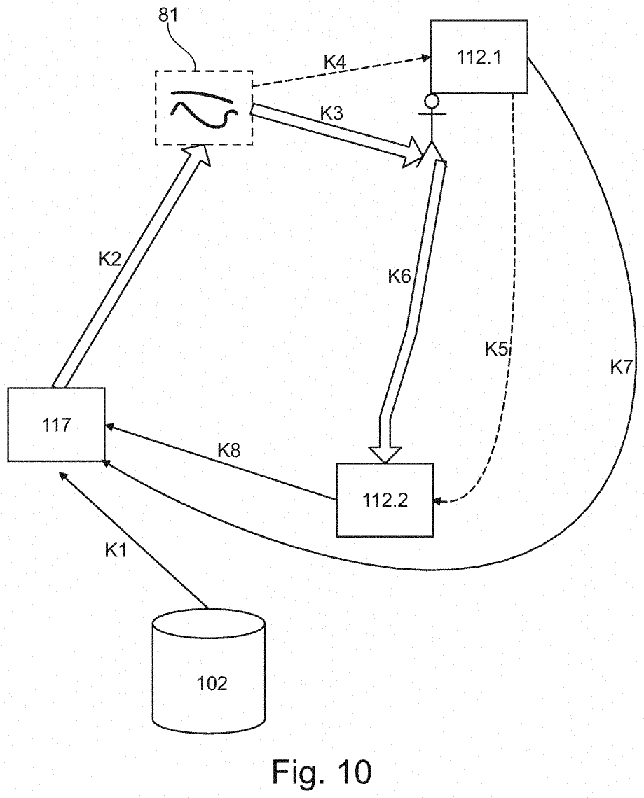

FIG. 10 schematically shows an optional configuration of the evaluation unit 52. According to FIG. 10, the database 102 is provided and stores the data sets containing the measured values obtained from the sensors 60-62. It should be pointed out that for the sake of simplicity reference is primarily made to the sensors 60-62, but the data sets may originate from Internet of Things (IoT) devices, an engine control unit ECU or any other apparatus for acquiring physical data. Optionally, each data set has measured values that each span an equal time period. Each data set may include measured values from one or in particular more sensors 60-62.

The data sets stored in the database 102 are provided to the block 117 (which is, for example, the block 117 explained in connection with FIG. 4) via a communication connection K1.

The block 117 provides (in particular successively) a portion of the data sets stored in the database 102 as candidates to the interface 81 via a communication connection K2. The measured values of the respective candidates are displayed via the interface 81 (communication connection K3), with the result that a user may classify them by making appropriate inputs via the interface 81. In addition to the classification, the user selects a portion of the measured values in the respective data set that includes fewer measured values than the entire corresponding data set. This is the portion of the measured values which gives rise to the respective classification. The user may be an expert who may identify anomalies in the data sets with a particularly good hit rate based on their experience (but who is unable to classify the potentially enormous amounts of data sets from the database 102). An anomaly may be exceeding a threshold value, a specific trend, a sudden change, or the like.

Block 112.1 represents, for example, part of block 112 explained with reference to FIG. 4. This block 112.1 includes an algorithm for learning features of the candidates, for example, in the form of a neural network or a so-called variational autoencoder. Data parameters (e.g., signals) and features (e.g., in the form of the parameters described above) selected by the user (in particular for the (time) domain) are used to train the algorithm. This receives (via the communication connection K4), e.g., the complete candidate data as displayed to the user as input and the portion of the data selected by the user as output. The features of a respective candidate are represented, for example, by numerical values inserted in a one-dimensional or multi-dimensional vector space.

Based on the features determined in block 112.1 (which are transmitted via a communication connection K5), a further machine learning model is created in block 112.2, for example, in the form of a random forest classifier, a logistic regressor, or a so-called support vector machine. This machine learning model is designed to predict whether or not a further (new, unclassified) data set has an anomaly. Block 112.2 represents, for example, part of block 112 explained with reference to FIG. 4. Block 112.2 also receives the user's classification via a communication connection K6. The machine learning model represents a classification learning algorithm.

The flow of information for training machine learning models takes place via the communication connections K4 and K5 (dashed lines).

The next candidate to be displayed to the user in each case is determined by active learning. For this purpose, for example, the trained algorithm for learning features is used for each candidate (e.g., each data set stored in the database 102) in order to determine features of the candidates. Furthermore, the classification learning algorithm is used to determine which of the candidates is the one that promises the greatest learning effect (is the newest in terms of its features, so to speak). For this purpose, for example, a distance to a separation boundary between different classes and/or to a separation boundary of a single class is determined. Alternatively, or additionally, the maximum information content that is relevant to the machine learning model is determined. For example, an entropy value is determined.

For this purpose, blocks 112.1 and 112.2 are connected via communication connections K7, K8.

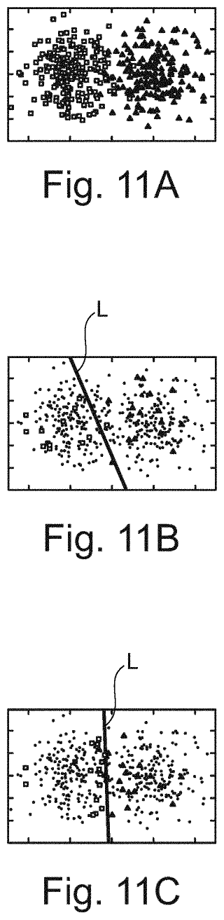

FIGS. 11A to 11C illustrate optional details of active learning. FIG. 11A shows, by way of example, features of a multiplicity of candidates plotted in two dimensions (e.g., two different temperature or pressure values or the like). Each plotted point represents a candidate in this case. The candidates are divided into two classes in this case and the task of the classification learning algorithm (e.g., in the form of the machine learning model 51 or 57) is to find out which class the candidates belong to. The classes correspond to various states of the gas turbine engine 10 or of a machine in general. For example, one class indicates a defective state, and the other class indicates a correct state.

FIG. 11B shows the same candidates, wherein some randomly selected candidates that have been classified and used to train the classification learning algorithm are highlighted. Based on this, a separation line L separating the classes is drawn. This is sub-optimal.

FIG. 11C highlights candidates selected by active learning. These result in a separation line (e.g., determined using a regression algorithm) which enables a much better separation of the classes. By active learning, for example, the candidate closest to the separation line is selected for this purpose. Alternatively, or additionally, the candidates having the lowest confidence level in the prediction of the class are selected. Alternatively, or additionally, so-called entropy sampling is used. In this way, the most informative data sets are selected. This also enables training that is not only particularly precise but may also produce robust predictions particularly quickly.

The separation line may be curved or straight, and also part of a multi-dimensional separation boundary.

The disclosure is not limited to the embodiments described above, and various modifications and improvements may be made without departing from the concepts described herein. Any of the features may be used separately or in combination with any other features, unless they are mutually exclusive, and the disclosure extends to and includes all combinations and sub-combinations of one or more features that are described herein.

In particular, instead of the gas turbine engine 10, another machine, such as a motor and/or engine, (e.g., a piston engine), may also be used.

### LIST OF REFERENCE SIGNS

8 Aircraft
9 Main axis of rotation
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24 Stationary support structure
26 Shaft
27 Connecting shaft
30 Gear box
50 Sensor system
51 Machine learning model
52 Evaluation unit
53 Memory
54 Instructions
55 Processor
56 Selector
57 Higher-level machine learning model
58, 59 Communication interface
60-62 Sensor
70 Data (measured values)
71 Selected portion
80 Display
81 Interface
100-110 Database
111-119 Block
A Core air flow
B Bypass air flow
K1-K8 Communication connection
L Separation line

1. A sensor system for identifying a state of at least one machine, the sensor system comprising:
one or more sensors configured to acquire measured values of the at least one machine;
at least one communication interface; and
an evaluation unit configured to:
acquire a plurality of data sets containing the measured values of the one or more sensors;
select a portion of the plurality of data sets by active learning; and
provide the selected portion of the plurality of data sets to the at least one communication interface to identify the state of the at least one machine.

2. The sensor system of claim 1, wherein the evaluation unit is further configured to specify an order for the selected portion of the plurality of data sets by active learning.

3. The sensor system of claim 1, wherein the evaluation unit is further configured to:
divide the plurality of data sets into at least two groups with regard to at least one parameter of the plurality of data sets by a separation line; and
select the portion of the plurality of data sets based on a distance between the parameters of the respective data sets and the separation line.

4. The sensor system of claim 1, wherein the evaluation unit is further configured to receive a classification of the plurality of data sets provided at the at least one communication interface with regard to the state of the at least one machine.

5. The sensor system of claim 4, wherein the evaluation unit is further configured to analyze the classification of the plurality of data sets in order to acquire at least one parameter of a respective data set.

6. The sensor system of claim 5, wherein the evaluation unit is further configured to use the acquired at least one parameter to train a machine learning model.

7. The sensor system of claim 6, wherein the evaluation unit is further configured to use the trained machine learning model to classify further data sets containing measured values.

8. The sensor system of claim 1, wherein the at least one machine is at least one gas turbine engine.

9. A method for identifying a state of at least one machine, the method comprising:
generating measured values of the at least one machine by one or more sensors;
acquiring, with an evaluation unit, a plurality of data sets containing measured values of the one or more sensors;
selecting, with the evaluation unit and by active learning, a portion of the plurality of data sets;
providing the selected portion of the plurality of data sets to at least one communication interface; and
identifying the state of the at least one machine using the provided selected portion of the plurality of data sets.

10. The method of claim 9, further comprising:
specifying an order for the selected portion of the plurality of data sets by the active learning.

11. The method of claim 9, further comprising:
receiving, by the evaluation unit, a classification of the plurality of data sets provided at the at least one communication interface with regard to the state of the at least one machine,
training, by the evaluation unit, a machine learning model on the basis thereof;
using, by the evaluation unit, the trained machine learning model to classify further data sets containing measured values; and
servicing the corresponding machine depending on the classification of the further data sets.

12. A non-transitory computer program product comprising instructions which, when executed by one or more processors, cause the one or more processors to:
generate measured values of at least one machine by one or more sensors;
acquire a plurality of data sets containing measured values of the one or more sensors;
select, by active learning, a portion of the plurality of data sets;
provide the selected portion of the plurality of data sets to at least one communication interface; and
identify a state of the at least one machine using the provided selected portion of the plurality of data sets.

13. The method of claim 9, further comprising:
dividing, by the evaluation unit, the plurality of data sets into at least two groups with regard to at least one parameter of the plurality of data sets by a separation line; and
selecting, by the evaluation unit, the portion of the plurality of data sets based on a distance between the parameters of the respective data sets and the separation line.

14. The method of claim 9, further comprising:
receiving, by the evaluation unit, a classification of the plurality of data sets provided at the at least one communication interface with regard to the state of the at least one machine.

15. The method of claim 14, further comprising:
analyzing, by the evaluation unit, the classification of the plurality of data sets in order to acquire at least one parameter of a respective data set.

16. The method of claim 15, further comprising:
using, by the evaluation unit, the acquired at least one parameter to train a machine learning model.

17. The method of claim 16, further comprising:
using, by the evaluation unit, the trained machine learning model to classify further data sets containing measured values.
